(19) United States
(12) Patent Application Publication
(10) Pub. No.: US 2014/0021822 A1
(43) Pub. Date: Jan. 23, 2014

(54) ROTATING ELECTRICAL MACHINE

(71) Applicant: NIPPON PISTON RING CO., LTD, Saitama-shi (JP)

(72) Inventors: Masafumi SAKAMOTO, Shimotsuga-gun (JP); Shigeyoshi SATO, Shimotsuga-gun (JP); Shunsuke TAKEGUCHI, Shimotsuga-gun (JP)

(21) Appl. No.: 13/945,055

(22) Filed: Jul. 18, 2013

(30) Foreign Application Priority Data
Jul. 20, 2012 (JP) 2012-161894

(51) Int. Cl. H02K 1/06

(52) U.S. Cl. CPC H02K 1/06
USPC 310/179

(57) ABSTRACT

To realize a highly efficient rotating electrical machine having high torque at low cost by a reliable method. The inner rotor type rotating electrical machine including a stator core and a rotor core facing each other, and a gap provided in a recessed and projected state between the stator core and the rotor core, the rotating electrical machine being featured in that the stator core includes at least an armature and is configured by assembling a plurality of divided dust cores.

### BACKGROUND OF THE INVENTION

1. Field of the Invention

The present invention relates to a rotating electrical machine, such as a small electric motor and generator.

2. Description of the Related Art

In the market, there has been a strong demand for miniaturization and thinning of rotating electrical machines which are small-sized to medium-sized electric motors or generators having output power of about 1 kW or less. Further, in recent years, demand for high-efficiency and energy-saving electric motors, as a global warming countermeasure, has been growing. Also, as for generators, as a result of reviewing the use of renewable energy as an alternative of nuclear power, the demand for a small wind power generator for home use has also been growing. Further, lower cost has also been strongly demanded. The rotating electrical machine is classified into a radial gap type rotating electrical machine and an axial gap type rotating electrical machine. The radial gap type rotating electrical machine has been widely used as a general purpose machine because of the advantages that the size of air gap can be reduced, and that the area facing the air gap can be easily increased in the shaft direction of the rotating electrical machine. However, because of the above-described reasons, further improvements in torque and efficiency have been required for the radial gap type rotating electrical machine.

Japanese Patent Laid-Open No. 2011-217454 discloses a technique as a prior art in which the torque characteristic is improved by increasing the area facing the air gap.

### SUMMARY OF THE INVENTION

1) In a conventional general purpose radial gap type rotating electrical machine, that is, in case of a brushless DC motor (hereinafter referred to as BLDC motor) and a synchronous generator in each of which a permanent magnet is used in a rotor, or in case of a switched reluctance motor (hereinafter referred to as SR motor) in which no permanent magnet is provided in the rotor but magnetic body teeth are provided, a technique is adopted in which the stator core is configured by laminating silicon steel plates, and in which, when low cost and efficiency are particularly required, the winding is formed by a concentrated winding method. This is because, in a distributed winding method, the coil end portion which does not contribute to torque generation is increased, so that copper loss is increased to reduce the efficiency, and because the winding and wiring become complicated. On the other hand, in the concentrated winding method, the winding is simple and can be directly wound around the slot, so that the winding is made less expensive. In the case of the concentrated winding method, when a rotating machine is practically configured, the number of stator slots is limited to four to twelve mainly in terms of cost of the rotating machine. An object of the present invention is to provide a rotating electrical machine which uses the advantages of the radial gap type rotating electrical machine and can be easily assembled, and which has significantly improved efficiency.

2) Japanese Patent Laid-Open No. 2011-217454 discloses a device in which the area facing the gap portion between the stator and the rotor is increased to improve the efficiency of a rotating electrical machine. In the prior art, the rotating electrical machine is configured such that the gap is not linearly formed in the shaft direction but is formed by mutually engaging depressions and projections which are respectively provided in the circumferential direction on portions of the stator and the rotor that face each other via the gap. Such gap structure is referred to as a three-dimensional gap. With such configuration, the area facing the gap between the stator and the rotor is increased, and thereby the efficiency and torque of the rotating electrical machine can be improved. However, since the gap is not formed along the straight line in the rotating electrical machine employing the three-dimensional gap, the stator and the rotor cannot be assembled in such a manner that the stator and the rotor are completed independently of one another, and that the rotor is inserted into the stator in the shaft direction. For this reason, and also in consideration of the iron loss of the stator core, the stator core is configured by laminated divided cores made of silicon steel plates. However, as also described in Japanese Patent Laid-Open No. 2011-217454, in this three-dimensional gap structure, the silicon steel plates, which configure the thrust direction portion of the three-dimensional gap portion, are deformed by magnetic attraction force, so that peeling and warping occur in the silicon steel plates. As a preventive measure for this, welding is performed at the three-dimensional gap portion. However, when welding is directly performed at the three-dimensional gap portion, eddy current loss is generated in the molten lump of iron. Further, the stator and the rotor may be brought into contact with each other via the molten lump of iron, and hence it is not preferred that the molten lump of iron exists in the three-dimensional gap portion. To cope with this, as shown in FIG. 4 of Japanese Patent Laid-Open No. 2011-217454, a double stator is formed by providing another stator 38 having recessed and projected portions, and the silicon steel plates are welded together at welding portions (W portions) of the stator 38, which are located on the side opposite to the gap between the stator and the rotor. For this reason, the cost of the rotating electrical machine employing this three-dimensional gap structure is estimated to be high. An object of the present invention is also to solve this problem.

3) In order to further improve the efficiency, it is necessary to utilize the area which is occupied by the coil end and which is not the area facing the rotor. The solutions of this problem include a method in which a so-called overhang is formed by projecting the shape of the stator winding pole in the shaft direction or in the circumferential direction of rotation with a dust core. In the structure formed by laminating silicon steel plates, this overhang structure is generally difficult or expensive.

4) In the three-dimensional gap structure of the divided-core stator, the time required for assembling the rotating electrical machine and the processing cost are increased, so that the cost of the rotating electrical machine is increased. An object of the present invention is also to provide a device to solve this problem.

5) The prior art corresponds to FIG. 3, FIG. 4 and FIG. 9 of Japanese Patent Laid-Open No. 2011-217454. In this specification, however, the prior art is shown in FIG. 5. In FIG. 5, a stator 21 is formed of laminated steel plates, a rotor 22 is formed of laminated steel plates, and a winding portion 23 is an armature. In this case, there is a problem that, due to the magnetic attraction force in the shaft-direction gap portion, warping, collapsing, or the like, of the silicon steel plates of the stator and the rotor is caused so that the silicon steel plate of the stator is brought into contact with the silicon steel plate of the rotor. An object of the present invention is also to solve this problem. Further, in the prior art of FIG. 5, the magnetic flux easily flows in the radial direction in the three-dimensional gap portion. However, the magnetic flux is more difficult to flow in the shaft direction that is the direction in which the silicon steel plates are laminated, than in the radial direction. This results in a problem that the effect of the three-dimensional structure is not sufficiently exhibited.

The present invention is realized by the following devices.

“Device 1”

An inner rotor type rotating electrical machine including a stator core and a rotor core facing each other, and a gap provided in a recessed and projected state between the stator core and the rotor core, the rotating electrical machine being realized by a device wherein the stator core includes at least an armature and is configured by assembling a plurality of divided dust cores.

“Device 2”

The rotating electrical machine as described in “device 1”, the rotating electrical machine including a positioning device for positioning the stator core, and being realized by a device wherein: a projecting portion projecting in the shaft direction is provided at each of the plurality of dust cores configuring the stator core; and the projecting portion and the positioning device are abutted against each other and thereby the stator core is positioned while maintaining the gap in the recessed and projected state.

“Device 3”

The rotating electrical machine as described in one of “device 1” and “device 2”, the rotating electrical machine being realized by a device wherein: a recessed portion for a winding is provided in the shaft direction at each of the plurality of cores configuring the stator core; and the axis-direction thickness of the recessed portion is uniform in the radial direction or the shaft-direction thickness of the stator core is reduced in the direction from the center to the outside of the stator core.

“Device 4”

The rotating electrical machine as described in one of “device 1” to “device 3”, the rotating electrical machine being realized by a device wherein: the rotor core is configured by assembling a plurality of divided dust cores.

“Device 5”

The rotating electrical machine as described in “device 4”, the rotating electrical machine including a support device for supporting the rotor core, and being realized by a device wherein: a projecting portion or a recessed portion is provided in the shaft direction at each of the plurality of dust cores configuring the rotor core; and the projecting portion or the recessed portion is fitted to the support device and thereby the plurality of dust cores of the rotor core are supported and prevented from separating from each other in the radial direction.

(1) The gap between the stator core and the rotor core is formed in the recessed and projected state, that is, the stator core and the rotor core face each other via a three-dimensional gap, and hence the facing area of the stator and the rotor is increased, so that a highly efficient rotating electrical machine with a gap portion having high permeance is realized at low cost.

(2) Since the iron core is not formed by a lamination method of laminating silicon steel plates, it is not necessary that the silicon steel plates are welded together as in the case of the lamination method, and hence peeling or warping of the silicon steel plate due to the magnetic attraction force in the axis direction does not occur. Therefore, it is possible to obtain a rotating electrical machine which is less expensive and highly reliable. In the structure which is disclosed in Japanese Patent Laid-Open No. 2011-217454 and which is formed by laminating silicon steel plates, the magnetic flux is difficult to flow in the laminating direction (shaft direction). However, the compacted powder adopted in the present invention has no orientation and hence is suitable for the so-called three-dimensional gap.

(3) A projecting portion projecting in the shaft direction is provided at each of a plurality of iron cores configuring the stator core having an armature, and on the other hand, for example, positioning devices for positioning the stator core are provided at a bracket for supporting the rotor shaft so that each of the projecting portions and each of the positioning devices are abutted against each other. Thereby, the so-called three-dimensional gap in the recessed and projected state can be easily secured and maintained, so that the rotating electrical machine is realized at low cost.

(4) When a plurality of recessed portions for windings are respectively provided at a plurality of iron cores configuring the stator core so as to configure a so-called overhang structure, the facing area of the stator and the rotor can be further increased or the copper loss can be reduced, and hence a small and highly efficient rotating electrical machine is realized. Further, when the shaft-direction thickness of the stator core at the recessed portion for the winding is reduced from in the direction the center to the outside of the stator core, the space factor of the winding can be further increased, and hence the efficiency of the rotating electrical machine can be improved.

(5) When the rotor core is configured by a plurality of dust cores, peeling of silicon steel plates does not occur. Further, the dust core having the recessed and projected portion for the three-dimensional gap can be formed by molding at low cost. Further, the three-dimensional gap portion does not have orientation, and hence the magnetic flux is made to uniformly flow both in the radial direction and in the shaft direction.

(6) Projecting portions or recessed portions are respectively provided in the shaft direction at the plurality of iron cores configuring the rotor core, and on the other hand, support devices for supporting the rotor core are provided on the main body side of the rotating electrical machine, so as to be fitted to the projected portions or recessed portions, respectively. Thereby, it is possible to prevent that the divided iron cores are separated from each other by centrifugal force at the time of high speed rotation of the rotor.

(7) By the use of the dust core, a highly efficient rotating electrical machine is obtained, in which the eddy current loss is close to zero and in which the iron loss is small especially at the time of high speed rotation.

### BRIEF DESCRIPTION OF THE DRAWINGS

FIG. 1 is a sectional view including a shaft of a rotating machine according to an example of the present invention;

FIG. 2 is a sectional view taken along line II-II of FIG. 1;

FIG. 3 is a sectional view including a shaft of a rotating machine according to another example of the present invention;

FIG. 4 is a sectional view taken along line IV-IV of FIG. 3; and

FIG. 5 is a view showing a prior art.

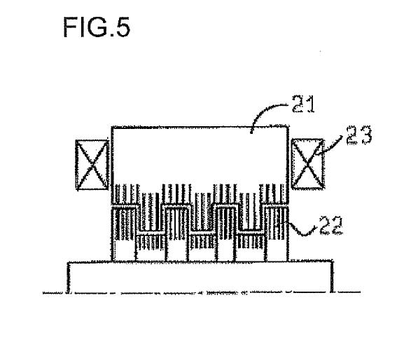

### DETAILED DESCRIPTION OF THE PREFERRED EMBODIMENTS

In the following, the present invention will be described with reference to the accompanying drawings.

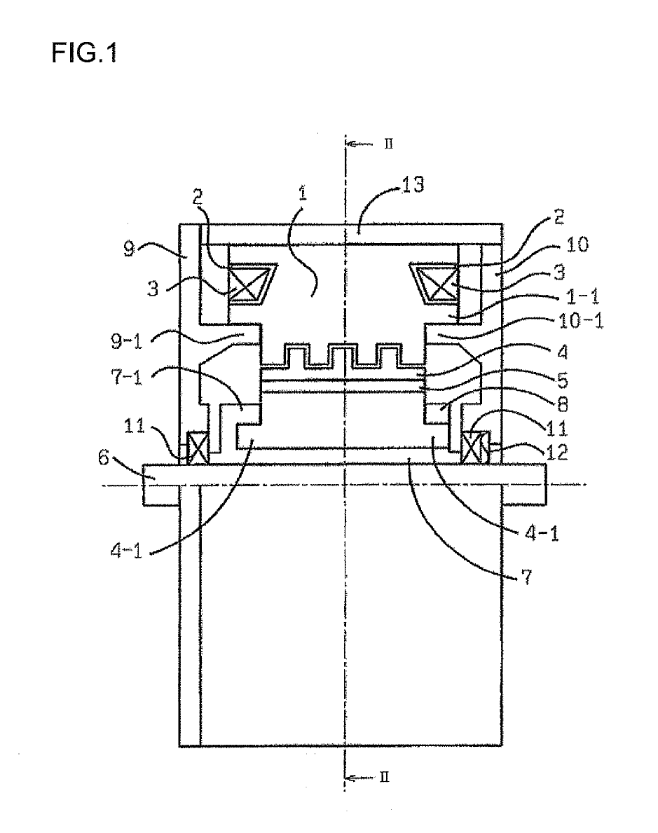

FIG. 1 shows an example of a configuration according to the present invention, and is a sectional view including a rotation axis center.

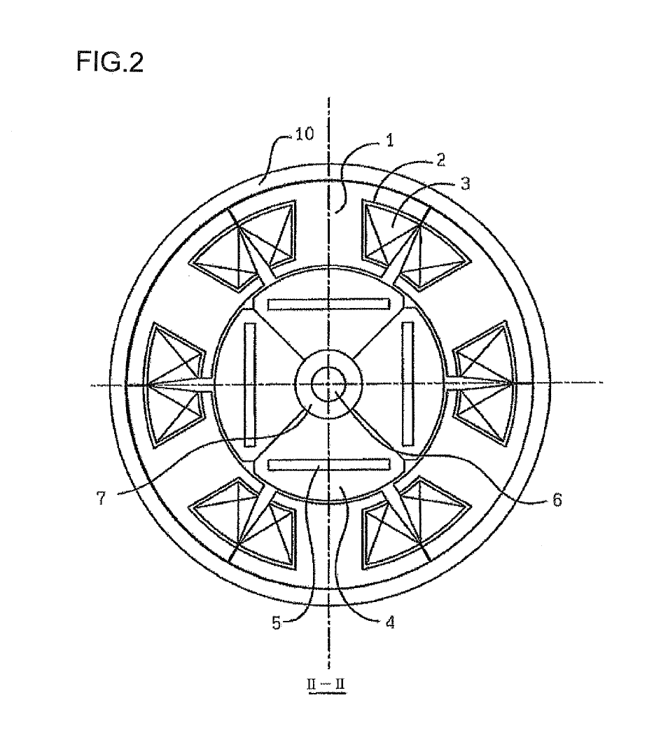

FIG. 2 is a sectional view taken along line II-II of FIG. 1 and seen from the direction of the rotation axis center.

FIG. 1 and FIG. 2 show a case in which the armature (winding) side is a stator, and the anti-armature side is a rotor, and in which the present invention is applied to a rotating electrical machine of a type using a rotor provided with a permanent magnet. Motors, such as a BLDC motor, are included in this type. However, an illustration of a Hall element portion for rotor position detection is omitted.

Generally, in a rotating electrical machine, such as a DC generator or a DC motor, in which a brush and a commutator are used to mechanically rectify AC to DC and mechanically convert DC to AC, the iron core portion having the winding portion, that is, the armature, is used as the rotor, and the iron core portion on the anti-armature side is used as the stator. On the other hand, in a BLDC motor, an SR motor, and the like, in which neither the brush nor the commutator is provided, the iron core portion having the armature is used as the stator, and the iron core portion on the anti-armature side is used as the rotor. The present invention relates to a three-dimensional gap type rotating electrical machine, and hence is particularly suitable for a so-called inner rotor type rotating electrical machine of the latter type, in which the armature is provided on the stator side and in which the rotor is provided on the anti-armature side that is located on the inner side of the stator side.

In FIG. 1 and FIG. 2, the stator core 1 has an armature formed of a dust core. Since a BLDC motor uses a permanent magnet and hence requires no electrical input for field magnetic flux, the motor is configured as a highly efficient rotating electrical machine. However, in recent years, among permanent magnets, the price of a rare-earth magnet, such as a neodymium magnet, having high magnetic energy has been significantly increased, and hence it is necessary to improve the efficiency of the BLDC motor while reducing the use amount of magnet and using a ferrite magnet having low magnetic energy. It can be said that the present invention is very effective for a solution of this problem.

The dust core is manufactured in such a manner that, by mixing soft magnetic iron powder with a small amount of resin as a lubricant or binder, the iron power particles are coated with the resin so that electrical insulation between the iron powder particles is increased to reduce eddy current, and that the mixture is compressed and molded and then sintered. In a rotating electrical machine using the dust core, the core can be formed into a complicated three-dimensional shape, while, in a rotating electrical machine using a core formed by laminating silicon steel plates, the core has a simple two-dimensional shape. Further, the core formed of the dust core has a characteristic that eddy current loss, which is a part of iron loss, is small. The dust core described above has a disadvantage that the magnetic flux density is lower than the core formed by laminating silicon steel plates. However, the dust core can be suitably used for improving the efficiency of the rotating electrical machine in such a manner that the dust core is formed into a so-called overhang shape in which the iron core can be further provided in areas around the coil end portion of the winding, that is, the armature portion so as to increase the facing area of the stator and the rotor. When the dust core is used, it is possible to easily form, in the rotating electrical machine, the overhang shape, a three-dimensional gap structure, and the like, which are difficult to be formed by using the method of laminating silicon steel plates.

FIG. 1 and FIG. 2 show a case of a rotating electrical machine including a three-phase stator core having six slots and a rotor core of four poles. The stator core 1 is configured in such a manner that the stator core 1 is divided into six portions, each of which is provided with a winding, are combined together. Each of the six divided portions of the stator 1 is provided with a portion projected in the shaft direction, that is, an overhang 1-1. The overhang 1-1 is also serves as the inner peripheral wall of a recessed portion for the winding. An insulator 2 is provided in the recessed portion for the winding, and a coil 3 is wound on the insulator 2. At this time, the recessed portion for the winding is formed so that the axis-direction thickness of the recessed portion is uniform in the radial direction or so that the shaft-direction thickness of the core at the recessed portion for the winding is reduced in the direction from the center to the outside of the stator 1. In FIG. 2, the coil 3 is wound in a fan shape expanding in the radial direction, and hence, in order that the winding end is formed to have the same height in the shaft direction, it is only necessary that the shaft-direction thickness of the core at the recessed portion for the winding is reduced in the direction from the center to the outside of the stator 1. Thereby, the space factor of the winding can be further increased, and hence the efficiency of the rotating electrical machine can be improved. In order to improve the efficiency, it is necessary to increase the space factor of the winding. In the case where the stator core is not divided into six portions but is configured by a single core, since, in a winding method of directly winding a copper wire in a core slot by a concentrated winding method, the copper wire is wound around the slot through a slot opening portion by using a nozzle, the winding space factor is about 20% to about 30%. In the case where the divided cores made of dust cores according to the present invention are used, the winding space factor can be significantly increased to 60% or more. The torque generated by a rotating electrical machine is proportional to the square root of the cross-sectional area of the coil, and hence it can be said that the divided-core structure is a structure advantageous for improving the efficiency of the rotating electrical machine.

In a portion of the stator core 1 which portion faces a rotor core 4, a gap in a recessed and projected state, that is, a so-called three-dimensional gap is provided. When the three-dimensional gap is provided, the facing area of the stator core and the rotor core can be easily increased to 2 to 3 times. The air gap permeance is proportional to the facing area and is inversely proportional to the distance of the air gap. For this reason, even when the three-dimensional gap is provided and thereby the distance of the air gap is increased to 1.5 times, the facing area is increased to 3 times, and hence the air gap permeance can be increased to 2 times. When the air gap permeance is large, the magnetic flux is increased. Therefore, it can be seen that the three-dimensional gap structure is a device which is effective to improve the efficiency of the rotating electrical machine. Further, in the conventional structure in which the portion facing the three-dimensional gap is formed by laminating silicon steel plates, the silicon steel plates are warped or peeled due to the magnetic attraction force in the axis direction, and hence the silicon steel plates need to be connected to each other by welding, or the like. However, in the structure using the dust core, such welding process is not needed, and hence the structure can be made highly reliable and less expensive. Note that the recessed and projected state is a concept which not only literally means a recessed and projected state but also means a jagged state having a triangular shaped cross-section, and a wavy state.

A permanent magnet 5 is embedded in a groove of the rotor core 4. The four permanent magnets 5 are alternately magnetized to polarities different in the radial direction, so that a four pole rotor is formed. Note that, as shown in FIG. 1 and FIG. 2, the rotor core 4 is configured by four divided dust cores and is provided with a cylindrical projecting portion 4-1 projecting in the shaft direction. A shaft 6 and the rotor core 4 are connected to each other by an inner component 7. At this time, the outer periphery and the end surface of the cylindrical projecting portion 4-1 on the left side of FIG. 1 are fixed to a grooved flange portion 7-1 provided at one end of the inner component 7. Further, an annular body 8, serving as a support device, is fitted to the outer peripheral portion of the right side end of the cylindrical projecting portion 4-1 in FIG. 1. Thereby, even when the rotor is configured by four divided iron cores, it is possible to prevent the divided iron cores from being separated from each other by centrifugal force at the time of high speed rotation.

Next, the sequence for assembling the rotating electrical machine according to the present invention will be described.

(1) In a view obtained by rotating FIG. 1 by 90 degrees counter-clockwise, a completed rotor body, in which bearings 11, such as ball bearings, are mounted to the above-described rotor, is mounted to a bracket 9. In this state, the shaft 6 is set in the vertical direction.

(2) Next, a bracket 10 is mounted to the bearing 11, such as a ball bearing, provided on the other upper end portion of the rotor. Note that a leaf spring 12, which applies pressure to the bearing 11, is attached to the lower end of the bearing 11.

(3) Next, six stator cores 1, each of which is provided with a winding, are combined together by being moved in the horizontal and reverse radial directions by using, as guides, the outer periphery of a cylindrical projecting portion 9-1 provided at the bracket 9 and the outer periphery of a cylindrical projecting section 10-1 provided at the bracket 10. At this time, even in the case where the permanent magnet 5 of the rotor is magnetized, each of the outer periphery of the projecting portion 9-1 and the outer periphery of the projecting portion 10-1 serves as a stopper guide against the magnetic attraction force in the radial direction, so that the stator and the rotor are prevented from being brought into contact with each other.

(4) Next, as required, a pipe-shaped housing 13 is inserted and fixed at the outer peripheral portion of the stator. Note that the pipe-shaped housing 13 can be easily inserted by shrink fitting. In the case where the pipe-shaped housing 13 is not used, it is preferred that the divided dust cores, which configure the stator core, be welded or bonded together.

With the above-described sequence, the rotating electrical machine according to the present invention can be surely and stably assembled.

In the SR motor, the field is generated without using the permanent magnet, and hence the cost of the SR motor can be reduced by the amount corresponding to the cost of the unnecessary expensive rare earth permanent magnet. However, the SR motor also has a disadvantage that, since the field is generated without using the permanent magnet, high torque is difficult to be generated. Therefore, the present invention provides an efficient rotating electrical machine in which the above-described disadvantages are improved.

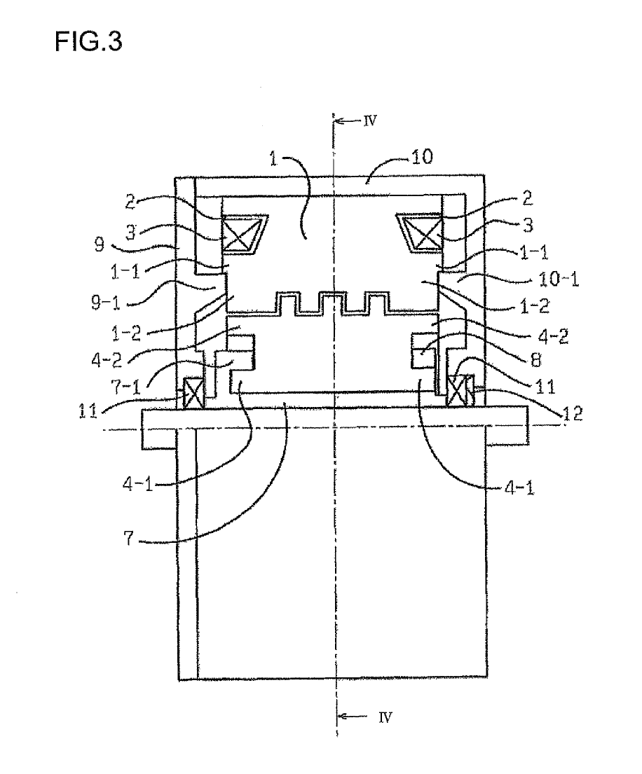

FIG. 3 shows an example of a configuration according to the present invention, and is a sectional view including a rotation axis center.

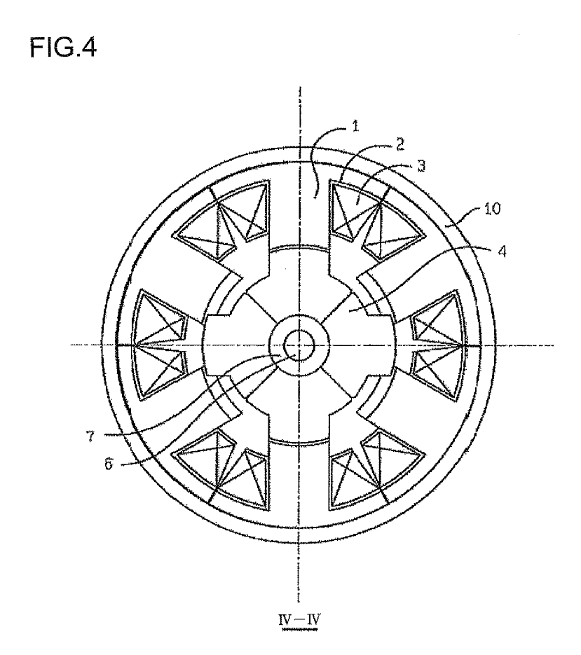

FIG. 4 is a sectional view taken along line IV-IV of FIG. 3 and seen from the direction of the rotation axis center.

In this case, a three-dimensional gap is adapted to an SR motor. Components common to those in FIG. 1 and FIG. 2 are denoted by the same reference numerals. FIG. 3 is different from FIG. 1 in the following two points.

(a) No permanent magnet is provided in the rotor core. Therefore, the divided stator cores are not attracted to the rotor core at the time of assembling the divided stator cores.

(b) The facing area of the stator core and the rotor core is increased more than the facing area in FIG. 1 by making the stator core and the rotor core face each other in the shaft direction in overhanging fashion.

A stator core portion 1-2 and a rotor core portion 4-2 are formed to face each other in overhanging fashion. In the case of FIG. 3, the facing area of the core portions facing each other in the shaft-direction in overhanging fashion can be made larger than the facing area in FIG. 1 because no permanent magnet is used and hence the back yoke core is not needed. Note that the basic structures of the stator core and the rotor core in FIG. 3 are the same as those in FIG. 1 and FIG. 2. The structures of the stator core and the rotor core in FIG. 3 are different from the structures in FIG. 1 and FIG. 2 in the two points (a) and (b) described above.

In the assembling method of this example, the same brackets 9 and 10, and the same housing 13 may be used in the same order as that in FIG. 1. In FIG. 3, the bracket 10 and the housing 13 shown in FIG. 1 are integrated with each other and used. In this case, the magnetic attraction force is not applied at the time of assembling, and hence the assembly sequence in FIG. 1 described above is changed to the sequence as described in (5) to (7).

(5) In a figure obtained by rotating FIG. 3 by 90 degrees counter-clockwise, a completed rotor body, in which the bearings 11, such as ball bearings, are mounted to the rotor core, is mounted to the bracket 9. In this state, the shaft 6 is set in the vertical direction.

(6) Next, the six stator cores 1, each of which is provided with a winding, are combined together in such a manner that the stator cores 1 are moved in the horizontal and reverse radial directions by using, as a guide, the outer periphery of the cylindrical projecting portion 9-1 provided at the bracket 9, so as to be fitted to the overhang 1-1.

(7) Next, the bracket 10 is fitted from above to the bearing 11, such as a ball bearing, provided at the other upper end portion of the rotor, and at the same time, the cylindrical projecting section 10-1 is fitted from above to the overhang 1-1.

The stator core and the rotor core in the case of FIG. 3 can be easily manufactured by powder compression molding for the dust core. Further, the rotor may be formed as a single piece by molding, but in this case, the recessed and projected groove portion of the three-dimensional gap portion of the single piece may need to be machined after the single piece is separated from the mold.

The number of poles of the stator core is not limited to six. Practically, in the case of two-phase rotating electrical machine, the stator core can be configured to have 2, 4, 8 or 12 poles, and in the case of three-phase rotating electrical machine, the stator core can be configured to have 6, 9 or 12 poles. Further, in the case of five-phase rotating electrical machine, the stator core can be configured to have 5 or 10 poles, and the like. The present invention can be suitably adapted to the case where concentrated windings are provided on the stator core having the above-described number of winding poles. However, even in the case where distributed windings are provided on a stator core having m slots which is larger than the above-described number of poles, the present invention can be adapted in such a manner that the number of division of the winding is set to a value p ranging from 2 to about 12, and that the number of slots included in one divided winding is set to a value n so as to satisfy the relationship of m=p·n.

The rotating electrical machine according to the present invention can be used for an electric motor or generator, and the present invention is very practical and suitable for obtaining a less expensive, small and light electric motor or generator having high mechanical strength, high torque and high efficiency. Therefore, it is expected that the present invention makes great industrial contributions.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2012-161894 filed on Jul. 20, 2012 including the specification, claims, drawings and summary is incorporated herein by reference in its entirety.

1. An inner rotor type rotating electrical machine including a stator core and a rotor core facing each other, and a gap provided in a recessed and projected state between the stator core and the rotor core,
wherein the stator core includes at least an armature and is configured by assembling a plurality of divided dust cores.

2. The rotating electrical machine according to claim 1, comprising
a positioning device for positioning the stator core,
wherein a projecting portion projecting in the shaft direction is provided at each of the plurality of dust cores configuring the stator core, and the projecting portion and the positioning device are abutted against each other and thereby the stator core is positioned while maintaining the gap in the recessed and projected state.

3. The rotating electrical machine according to claim 1,
wherein a recessed portion for a winding is provided in the shaft direction at each of the plurality of cores configuring the stator core, and
the axis-direction thickness of the recessed portion is uniform in the radial direction or the shaft-direction thickness of the stator core is reduced in the direction from the center to the outside of the stator core.

4. The rotating electrical machine according to claim 1, wherein the rotor core is configured by assembling a plurality of divided dust cores.

5. The rotating electrical machine according to claim 4, comprising
a support device for supporting the rotor core,
wherein a projecting portion or a recessed portion is provided in the shaft direction at each of the plurality of dust cores configuring the rotor core, and
the projecting portion or the recessed portion is fitted to the support device and thereby the plurality of dust cores of the rotor core are supported and prevented from separating from each other in the radial direction.
